(19) United States
(12) Patent Application Publication
(10) Pub. No.: US 2024/0242863 A1
(43) Pub. Date: Jul. 18, 2024

(54) NON-ORIENTED ELECTRICAL STEEL SHEET AND METHOD FOR MANUFACTURING SAME

(71) Applicant: POSCO Co., Ltd, Pohang-si, Gyeongsangbuk-do (KR)

(72) Inventors: Hyung Don Joo, Pohang-si, Gyeongsangbuk-do (KR); Jaewan Hong, Pohang-si, Gyeongsangbuk-do (KR); Yong-Soo Kim, Pohang-si, Gyeongsangbuk-do (KR); Junesoo Park, Pohang-si, Gyeongsangbuk-do (KR); Yunsu Kim, Pohang-si, Gyeongsangbuk-do (KR)

(73) Assignee: POSCO Co., Ltd, Pohang-si, Gyeongsangbuk-do (KR)

(21) Appl. No.: 18/288,286

(22) PCT Filed: Dec. 20, 2022
(86) PCT No.: PCT/KR2022/020833

§ 371 Date: Oct. 25, 2023

(30) Foreign Application Priority Data
Dec. 22, 2021 (KR) 10-2021-0184559

(51) Int. Cl. H01F 1/147; C21D 8/12; C21D 9/46; C22C 38/02; C22C 38/04; C22C 38/06; C22C 38/14; C22C 38/16; C22C 38/60

(52) U.S. Cl. CPC H01F 1/14783; C21D 8/1222; C21D 8/1233; C21D 8/1261; C21D 8/1277; C21D 9/46; C22C 38/02; C22C 38/04; C22C 38/06; C22C 38/14; C22C 38/16; C22C 38/60; C22C 2202/02

(57) ABSTRACT

A non-oriented electrical steel sheet according to an exemplary embodiment of the present invention contains, by wt %: 0.005% or less (excluding 0%) of C, 1.5 to 3.0% of Si, 0.4 to 1.5% of Mn, 0.005% or less (excluding 0%) of S, 0.0001 to 0.7% of Al, 0.005% or less (excluding 0%) of N, 0.005% or less (excluding 0%) of Ti, 0.001 to 0.02% of Cu, 0.01 to 0.05% of Sb, 0.001 to 0.1% of Sn, and 0.005 to 0.07% of P, wherein contents of Mn, Si, and Al satisfy the following [Expression 1], contents of Sb, Sn, and P satisfy the following [Expression 2], the non-oriented electrical steel sheet contains a balance of Fe and unavoidably incorporated impurities, and the number of (Mn, Cu)S precipitates of 0.5 μm or less per area is 1/μm³ or less:

$$0.19 \leq [ Mn ] / ( [ Si ] + 150 \times [ Al ] ) \leq 0.35 \qquad [ Expression 1 ]$$

$$1 / {2}^{*} Sn < [ Sb ] + [ P ] < 0.09 . \qquad [ Expression 2 ]$$

### TECHNICAL FIELD

An exemplary embodiment of the present invention relates to a non-oriented electrical steel sheet and a method for manufacturing the same. More particularly, an exemplary embodiment of the present invention relates to a non-oriented electrical steel sheet having excellent magnetic flux density and iron loss and also having excellent surface properties by optimizing alloy components and process conditions, and a method for manufacturing the same.

### BACKGROUND ART

A motor or generator is an energy conversion device that converts electrical energy into mechanical energy or mechanical energy into electrical energy, and recently, in accordance with strengthening of regulations on environmental conservation and energy saving, a demand for improving the efficiency of the motor or generator has increased. Since an iron core material is used in such a motor, generator, small transformer, or the like and a non-oriented electrical steel sheet is mainly used in the iron core material, characteristics of the electrical steel sheet should be further improved.

Energy efficiency in a motor or generator refers to a ratio of input energy to output energy, and in order to improve efficiency, it is important how much energy loss that is lost in an energy conversion process, such as iron loss, copper loss, or mechanical loss, may be reduced. Iron loss and magnetic flux density of a commonly known non-oriented electrical steel sheet affect iron loss and copper loss of the motor.

As iron loss of the non-oriented electrical steel sheet decreases, the iron loss in a process of magnetizing the iron core is reduced, resulting in improvement of the efficiency of the motor. In addition, as the magnetic flux density increases, a lager magnetic field may be induced with the same energy. Accordingly, since a less current may be applied to obtain the same magnetic flux density, the energy efficiency may be improved by reducing copper loss. Therefore, in order to improve the energy efficiency, the development of a technology of a non-oriented electrical steel sheet having excellent magnetism with low iron loss and high magnetic flux density is demanded.

As a method for reducing the iron loss in the non-oriented electrical steel sheet, there is a method of increasing the amount of Si, Al, and Mn added, which are elements having high resistivity. When the amount of Si, Al, and Mn added is increased, resistivity of steel is increased to reduce an eddy current loss of the non-oriented electrical steel sheet, which is effective in reducing the iron loss, however, as the amount of these elements added increases, the iron loss is not unconditionally reduced in proportion to the amount of these elements added. In addition, when the amount of alloying elements added is increased, the magnetic flux density is decreased, and therefore, it is not easy to secure both a reduction in iron loss and excellent magnetic flux density.

As a method capable of improving both the iron loss and magnetic flux density without sacrificing either the iron loss or magnetic flux density, there is a method of forming many {100} and {110} textures favorable to magnetism and forming fewer {111} and {112} textures unfavorable to magnetism. As a method for improving the texture in the non-oriented electrical steel sheet, a technique of performing a hot-rolled sheet annealing process in a step before cold rolling of a hot-rolled sheet after hot rolling of a slab has been used.

The hot-rolled sheet annealing process prevents non-uniformity of a steel sheet structure that occurs during a cooling process after coiling after annealing of a hot-rolled sheet, and makes precipitate or microstructure uniform in a width direction and a length direction of a coil, which may be effective in reducing deviations in iron loss and magnetic flux density in the width direction and the length direction of the coil.

However, when the hot-rolled sheet annealing process is added to improve the texture, manufacturing costs increase. In addition, when the hot-rolled sheet annealing process is added, there is also a technical problem that cold rolling properties are deteriorated due to coarse grains of steel.

Therefore, in the case of manufacturing a non-oriented electrical steel sheet capable of exhibiting excellent magnetism without performing a hot-rolled sheet annealing process, the manufacturing costs may be reduced, and the problem of productivity according to the hot-rolled sheet annealing process may be solved.

In order to reduce the manufacturing costs, there is a method in which a low-grade non-oriented electrical steel sheet having a low content of Si is used and a hot-rolled sheet annealing process is not performed. However, most of high-grade non-oriented electrical steel sheets containing 1.5 wt % or more of Si are subjected to a hot-rolled sheet annealing process to secure uniformity of structures and magnetic properties, and as the content of Si increases (for example, 1.8 wt % or more), the hot-rolled sheet annealing process is essential.

Nevertheless, various methods in which the hot-rolled sheet annealing process for the non-oriented electrical steel sheet having excellent magnetic properties is omitted have been suggested.

However, although various methods that do not perform such a hot-rolled sheet annealing process may secure magnetic properties, these methods have a problem of being significantly vulnerable to surface defects, and causes or solutions for these surface defects have not been suggested.

Furthermore, when the hot-rolled sheet annealing process is not performed, there is also a need to solve the problem that a difference in magnetic properties in the width direction or the length direction of the coil may further increase.

### DISCLOSURE

### Technical Problem

An exemplary embodiment of the present invention provides a non-oriented electrical steel sheet and a method for manufacturing the same.

Another exemplary embodiment of the present invention provides a non-oriented electrical steel sheet having both excellent magnetic properties and surface properties by controlling alloy components and also optimizing a series of process conditions during slab heating and hot rolling, and a method for manufacturing the same.

### Technical Solution

An exemplary embodiment of the present invention provides a non-oriented electrical steel sheet containing, by wt %: 0.005% or less (excluding 0%) of C, 1.5 to 3.0% of Si, 0.4 to 1.5% of Mn, 0.005% or less (excluding 0%) of S, 0.0001 to 0.7% of Al, 0.005% or less (excluding 0%) of N, 0.005% or less (excluding 0%) of Ti, 0.001 to 0.02% of Cu, 0.01 to 0.05% of Sb, 0.001 to 0.1% of Sn, and 0.005 to 0.07% of P, wherein contents of Mn, Si, and Al satisfy the following [Expression 1], contents of Sb, Sn, and P satisfy the following [Expression 2], the non-oriented electrical steel sheet contains a balance of Fe and unavoidably incorporated impurities, and the number of (Mn, Cu)S precipitates of 0.5 μm or less per area is 1/μm³ or less.

$$0.19 \leq [ Mn ] / ( [ Si ] + 150 \times [ Al ] ) \leq 0.35 \qquad [ Expression 1 ]$$

$$1 / {2}^{*} Sn < [ Sb ] + [ P ] < 0 \text{.09} \qquad [ Expression 2 ]$$

(Wherein [Mn], [Si], [Al], [Sn], [Sb], and [P] are wt % of Mn, Si, Al, Sn, Sb, and P, respectively.)

In the non-oriented electrical steel sheet according to an exemplary embodiment of the present invention, a number ratio (Fcount) of (Mn, Cu)S precipitates having a size of 0.05 μm or more to the (Mn, Cu)S precipitates of 0.5 μm or less may be 0.2 to 0.5, and an area ratio (Fcount×Farea) of the (Mn, Cu)S precipitates having a size of 0.05 μm or more to the (Mn, Cu)S precipitates of 0.5 μm or less may be greater than 0.15.

The electrical steel sheet may have a maximum height from the center line of 2.5 μm or less when measured in a length unit of 4 mm in a rolling direction based on the center line of a surface height, the electrical steel sheet may have the number of concavo-convex defects having a height greater than a peripheral height and having a width of 0.5 μm or more in a direction perpendicular to the rolling direction and a size of 3 cm or more in the rolling direction of 1/cm or less per 10 cm in the direction perpendicular to the rolling direction, and a change in {100} and {110} fractions at different positions of the electrical steel sheet may be less than 10%.

In addition, in the electrical steel sheet, a difference in iron loss values between an edge portion and a center portion in a coil width direction may be 5% or less, and a difference in magnetic flux density values between the edge portion and the center portion in the coil width direction may be 5% or less.

In addition, a thickness of an inner oxide layer of the electrical steel sheet based on a hot-rolled sheet of the electrical steel sheet may be 7 μm or less.

Another exemplary embodiment of the present invention provides a method for manufacturing a non-oriented electrical steel sheet, the method including: preparing a slab containing, by wt %, 0.005% or less (excluding 0%) of C, 1.5 to 3.0% of Si, 0.4 to 1.5% of Mn, 0.005% or less (excluding 0%) of S, 0.0001 to 0.7% of Al, 0.005% or less (excluding 0%) of N, 0.005% or less (excluding 0%) of Ti, 0.001 to 0.02% of Cu, 0.01 to 0.05% of Sb, 0.001 to 0.1% of Sn, and 0.005 to 0.07% of P, in which contents of Mn, Si, and Al satisfy the following [Expression 1] and contents of Sb, Sn, and P satisfy the following [Expression 2], the slab containing a balance of Fe and unavoidably incorporated impurities; reheating the slab at a temperature that satisfies the following [Expression 5]; hot rolling the reheated slab to manufacture a hot-rolled sheet; coiling the hot-rolled sheet into a coil shape; pickling the coiled hot-rolled sheet and cold rolling the pickled hot-rolled sheet to manufacture a cold-rolled sheet; and subjecting the cold-rolled sheet to final annealing.

$${MnS}_{SRT} / {MnS}_{Max} \geq 0.6 \qquad [ Expression 5 ]$$

(Wherein MnS_{SRT} is an equilibrium precipitation amount of MnS, and MnS_{Max} is a maximum precipitation amount of MnS.)

The reheating of the slab may be performed to a temperature that satisfies the following [Expression 6].

$$S R T \geq A 1 + 150 ° C . \qquad [ Expression 6 ]$$

(Wherein SRT is a slab reheating temperature, and Al is a temperature at which 100% of austenite is transformed into ferrite.)

In addition, in the reheating of the slab, the slab may be heated stepwise in two or more stages by setting a residence time to 100 minutes or longer.

Meanwhile, in the reheating of the slab, the slab may be heated stepwise in three or more stages by setting a residence time to 100 minutes or longer, a first stage heating may be performed at a temperature of (SRT_max−50°) C or lower for 50 minutes or longer, a second stage heating may be performed at a heating temperature (SRT2) in a heating furnace at a stage before the last stage that satisfies A3 temperature+70° C. or lower and A1+120° C. or higher, and the last heating may be performed at SRT_max≥A1+150° C.

(Wherein SRT_max represents the highest temperature among slab reheating temperatures (SRT) in [Expression 6].) In addition, when finishing rolling is performed in the hot rolling, a temperature just before the start of the finishing rolling may be a temperature of A1−50° C. or higher and A1+40° C. or lower.

When finishing rolling is performed in the hot rolling, among a plurality of rolls, a reduction ratio of a roll just before the last roll may be 21% or more, and a reduction ratio of the last roll may be 13% or more.

In addition, the coiling is preferably performed at 650 to 800° C.

Meanwhile, the coiling may be performed by controlling the temperature according to contents of Sn and Sb at a temperature calculated according to the following [Expression 3] and/or [Expression 4].

$${0.000165}^{*} C T - 0.085 < \{ 1 / {3}^{⋆} [ Sn ] + [ Sb ] \} < 0 \text{.13} \qquad [ Expression 3 ]$$

$${0.000165}^{*} C T - 0.0934 < [ Sb ] < 0.05 650 to 800 ° C . \qquad [ Expression 4 ]$$

(Wherein [Sn] and [Sb] are wt % of Sn and Sb, respectively, and CT is an average coiling temperature at a length of 30% of the total length located in the center in a length direction during the hot rolling.)

In addition, the coiling may be performed according to the following [Expression 7] representing that a temperature at a front end of the coil is higher than a temperature at a middle portion of the coil by 20° C. or more.

(Maximum coiling temperature at length from start point to point of 5% of total length in coil length direction)≥(average coiling temperature at length of 30% to 50% of total length in coil length direction)+20° C. [Expression 7]

Meanwhile, in the coiling of the hot-rolled sheet, the coiled coil may be cooled while being put into a cooling facility and covered with a heat retention cover.

In addition, the final annealing is preferably performed in a temperature range of 850 to 1,100° C.

As for the non-oriented electrical steel sheet according to an exemplary embodiment of the present invention, even when hot-rolled sheet annealing is omitted, it is possible to provide a non-oriented electrical steel sheet exhibiting excellent magnetic properties such as iron loss and magnetic flux density by precisely controlling dynamic recrystallization generating components such as Si, Al, and Mn and precipitate generating components such as Sb, Sn, and P, and at the same time, by controlling slab heating conditions and continuous detailed process conditions of hot rolling in a complex manner.

As for the non-oriented electrical steel sheet according to an exemplary embodiment of the present invention, even when the hot-rolled sheet annealing is omitted, it is possible to provide a non-oriented electrical steel sheet having excellent surface quality by controlling the components of alloying elements and precisely controlling a series of manufacturing process conditions.

As for the non-oriented electrical steel sheet according to an exemplary embodiment of the present invention, even when the hot-rolled sheet annealing is omitted, it is possible to provide a high-quality non-oriented electrical steel sheet in which a difference in magnetic properties in the length direction and the width direction of the coil by controlling the components of alloying elements and precisely controlling a series of manufacturing process conditions.

The non-oriented electrical steel sheet according to an exemplary embodiment of the present invention has excellent uniform magnetic properties in both a length direction and a width direction of the steel sheet and also has excellent surface properties. Due to these technical effects, the non-oriented electrical steel sheet manufactured according to an exemplary embodiment of the present invention may greatly improve efficiency of a device rotating at a high speed, such as a drive motor of an electric vehicle.

### DESCRIPTION OF THE DRAWINGS

FIG. 1 is a steel sheet photograph showing stripes formed on a surface of a non-oriented electrical steel sheet.

### MODE FOR INVENTION

The terms “first”, “second”, “third”, and the like are used to describe various parts, components, regions, layers, and/or sections, but are not limited thereto. These terms are only used to differentiate a specific part, component, region, layer, or section from another part, component, region, layer, or section. Accordingly, a first part, component, region, layer, or section which will be described hereinafter may be referred to as a second part, component, region, layer, or section without departing from the scope of the present invention.

Terminologies used herein are to mention only a specific exemplary embodiment, and are not to limit the present invention. Singular forms used herein include plural forms as long as phrases do not clearly indicate an opposite meaning. The term “comprising” used in the specification concretely indicates specific properties, regions, integers, steps, operations, elements, and/or components, and is not to exclude the presence or addition of other specific properties, regions, integers, steps, operations, elements, and/or components.

When any part is positioned “on” or “above” another part, it means that the part may be directly on or above the other part or another part may be interposed therebetween. In contrast, when any part is positioned “directly on” another part, it means that there is no part interposed therebetween.

Unless defined otherwise, all terms including technical terms and scientific terms used herein have the same meanings as understood by those skilled in the art to which the present invention pertains. Terms defined in a generally used dictionary are additionally interpreted as having the meanings matched to the related technical document and the currently disclosed contents, and are not interpreted as ideal or very formal meanings unless otherwise defined.

In addition, unless otherwise stated, % means wt %, and 1 ppm is 0.0001 wt %.

In an exemplary embodiment of the present invention, the meaning of “further containing an additional element” means that the additional element is substituted for a balance of iron (Fe) by the amount of additional element added.

Hereinafter, exemplary embodiments of the present invention will be described in detail so that those skilled in the art to which the present invention pertains may easily practice the present invention. However, the present invention may be implemented in various different forms and is not limited to exemplary embodiments described herein.

It is known that, in a non-oriented electrical steel sheet, when hot-rolled sheet annealing is performed, properties of a hot-rolled sheet do not significantly affect properties of a final product because properties of a microstructure and inclusions may be controlled according to conditions of the hot-rolled sheet annealing.

However, when the hot-rolled sheet annealing having these advantages is not performed, the product is completed through hot rolling, cold rolling, and final annealing processes, and therefore, it may be considered that the properties of the microstructure and inclusions of the hot-rolled sheet have an important influence on the properties of the final product.

Therefore, when the hot-rolled sheet annealing is not performed, an additional component system and hot rolling conditions that may secure excellent magnetism in the final product should be examined. As a result of a lot of studies on this, the present inventors have found that, in the hot rolling process, when an appropriate component system undergoing phase transformation and hot rolling conditions suitable for the component system are applied in detail, a recrystallized structure rather than a deformed structure is secured after hot rolling, and microstructure and sulfide size and distribution control is performed, such that it is possible to manufacture a non-oriented electrical steel sheet having excellent magnetism even when the hot-rolled sheet annealing is omitted.

First, a component system of the present invention will be described based on the examination results as described above.

Si, Al, and Mn will be first described as elements that affect magnetism when the hot-rolled sheet annealing is not performed in an exemplary embodiment of the present invention. Si, Al, and Mn are elements that determine resistivity of steel and also affect phase transformation behavior during hot rolling.

Here, Si and Al are ferrite stabilizing elements, and Mn is an austenite stabilizing element. Therefore, in order to cause phase transformation during hot rolling while securing low iron loss characteristics in the non-oriented electrical steel sheet, it is required to appropriately control the amount of Si, Al, and Mn added.

The present inventors closely analyzed the resistivity and the phase transformation behavior of the component system to derive an appropriate addition range for precisely controlling the amount of Si, Al, and Mn added as shown in [Expression 1] described below. As described above, when the content ranges of Si, Al, and Mn suggested in an exemplary embodiment of the present invention are satisfied, the rolling conditions during the hot rolling are precisely controlled, such that it is possible to manufacture a non-oriented electrical steel sheet having excellent magnetism even when the hot-rolled sheet annealing is omitted.

In addition, the present inventors confirmed that, when Si is slightly increased, the content of Mn should also be increased, and elements such as Sb, Sn, and P, which may improve the texture, should be added according to the increase of Si. An appropriate amount of elements added, such as Sb, Sn, and P, may be controlled by [Expression 2] described below.

Hereinafter, a composition of a non-oriented electrical steel sheet according to an exemplary embodiment of the present disclosure will be described.

The non-oriented electrical steel sheet according to an exemplary embodiment of the present disclosure contains, by wt %: 0.005% or less (excluding 0%) of C, 1.5 to 3.0% of Si, 0.4 to 1.5% of Mn, 0.005% or less (excluding 0%) of S, 0.0001 to 0.7% of Al, 0.005% or less (excluding 0%) of N, 0.005% or less (excluding 0%) of Ti, 0.001 to 0.02% of Cu, 0.01 to 0.05% of Sb, 0.001 to 0.1% of Sn, 0.005 to 0.07% of P, and a balance of Fe and unavoidable impurities. In this case, contents of Si, Mn, and Al satisfy the following [Expression 1], and contents of Sb, Sn, and P satisfy the following [Expression 2].

$$0.19 \leq [ Mn ] / ( [ Si ] + 150 \times [ Al ] ) \leq 0.35 \qquad [ Expression 1 ]$$

$$1 / {2}^{*} Sn < [ Sb ] + [ P ] < 0 \text{.09} \qquad [ Expression 2 ]$$

(Wherein [Mn], [Si], [Al], [Sn], [Sb], and [P] are wt % of Mn, Si, Al, Sn, Sb, and P, respectively.)

First, the reason for limiting the components of the non-oriented electrical steel sheet will be described.

### [C: 0.005 wt % or Less (Excluding 0%)]

Carbon (C) is combined with Th, Nb, and the like to form a carbide, resulting in deterioration of magnetism, and may cause a decrease in efficiency of electrical equipment due to an increase in iron loss caused by magnetic aging when used after processing from a final product to an electrical product.

Therefore, C may be limited to 0.005 wt % or less.

### [Si: 1.5 to 3.0 wt %]

Silicon (Si) is an element added to reduce eddy current loss of iron loss by increasing resistivity of steel. When the amount of Si added is too small, iron loss may be deteriorated. Therefore, it is advantageous to increase the content of Si from the viewpoint of increasing the resistivity; however, since Si is a ferrite stabilizing element, an austenite region decreases as the amount of Si added increases. Therefore, when a hot-rolled sheet annealing process is omitted, it is preferable to limit the amount of Si added to 3.0% or less in order to utilize phase transformation.

### [Mn: 0.4 to 1.5 wt %]

Manganese (Mn) is an element that reduces the iron loss by increasing the resistivity along with Si, Al, and the like, and improves the texture. When the amount of Mn added is too small, the effect of increasing the resistivity is low. Unlike Si and Al, Mn is an element that stabilizes austenite, and therefore, it is required to add an appropriate amount of Mn in relation to the amount of Si and Al added. For example, when the contents of Si and Al are increased, it is required to relatively increase the amount of Mn added to form austenite. However, when Mn is excessively added, a texture unfavorable to magnetism is formed, which may cause a reduction in magnetic flux density. Therefore, the amount of Mn added is preferably 0.4 to 1.5%.

### [S: 0.005 wt % or Less (Excluding 0%)]

Sulfur (S) forms fine sulfides such as MnS, CuS, and (Cu, Mn)S inside a base material and thus inhibits grain growth, which causes deterioration of the iron loss, and therefore, it is preferable that S is added as little as possible. When a large amount of S is contained, S is combined with other elements to increase formation of fine sulfides, which may cause deterioration of magnetism, and therefore, S may be limited to 0.005 wt % or less.

### [Al: 0.0001 to 0.7 wt %]

Aluminum (Al) serves to reduce the iron loss by increasing the resistivity along with Si, and also improves rolling properties or improves workability during cold rolling. When the amount of Al added is too small, there is no effect in reducing high-frequency iron loss. On the other hand, when the amount of Al added is too large, nitrides are excessively formed, which may cause deterioration of magnetism. In addition, Al is an element that stabilizes ferrite more than Si, and the magnetic flux density is greatly reduced as the amount of Al added increases, and therefore, the amount of Al added may be limited to 0.7% or less from the viewpoint of omitting the hot-rolled sheet annealing by utilizing the phase transformation phenomenon.

Here, the contents of Si, Mn, and Al preferably satisfy [Expression 1].

In [Expression 1], the content of Al should be controlled as a denominator together with Si because Al has a large effect of stabilizing ferrite, and Mn needs to be added in an appropriate amount to coarsen sulfide, and therefore, the contents of Si, Mn, and Al may be controlled at a molecular ratio as shown in [Expression 1]. As described above, when the contents of Si, Mn, and Al are controlled as shown in [Expression 1], the steel sheet has a sufficient austenite single-phase region at a high temperature, such that it is possible to secure a recrystallized structure after hot rolling through phase transformation during hot rolling, and it is possible to form coarse sulfides by controlling a hot-rolled recrystallization temperature.

### [N: 0.005 wt % or Less (Excluding 0%)]

Nitrogen (N) is combined with Al, Ti, Nb, and the like to form fine nitrides inside the base material and thus inhibits grain growth, which causes deterioration of iron loss, and thus, N is preferably contained in a small amount. Therefore, in an exemplary embodiment of the present invention, N may be limited to 0.005 wt % or less.

### [Ti: 0.005 wt % or Less (Excluding 0%)]

Titanium (Ti) is combined with C and N to form fine carbides or nitrides and thus inhibits grain growth, and thus, as a large amount of Ti is added, a large amount of carbides and nitrides is formed, which inhibits formation of a texture favorable to magnetism, resulting in deterioration of magnetism. Therefore, in an exemplary embodiment of the present invention, Ti may be limited to 0.005 wt % or less.

### [Cu: 0.001 to 0.02 wt %]

Copper (Cu) is an element that forms (Mn, Cu)S sulfides together with Mn. When the amount of Cu added is large, fine sulfides are formed, which causes deterioration of magnetism, and therefore, the amount of Cu added may be limited to 0.001 to 0.02%. In this case, Cu contained in the steel sheet may be intentionally added within the range suggested in an exemplary embodiment of the present invention, and may be present in a trace in a steelmaking process.

### [Sb: 0.01 to 0.05 wt %, Sn: 0.001 to 0.1 wt %, P: 0.005 to 0.07 wt %]

When Si or Al is increased to increase the resistivity of the steel sheet and the content of Mn is also increased to secure a fraction of an austenite phase, it is required to improve the magnetic flux density by improving the texture. For this purpose, it is preferable to add P, Sn, and Sb, and 0.01 wt % or more of Sb, 0.001 wt % or more of Sn, and 0.005 wt % or more of P may be added.

In this case, the contents of Sb, Sn, and P satisfy [Expression 2].

As described above, the reason for limiting the contents of Sb, Sn, and P will be described.

When the amount of Sb, Sn, and P added is too large, grain growth is inhibited and coating adhesion is reduced. Therefore, Sb may be limited to 0.05 wt % or less and Sn may be limited to 0.1 wt % or less in terms of the amount of these elements added. Here, when 0.02 wt % or more of Sb is contained, it is preferable that Sn is contained in an amount of less than 0.05 wt %. In addition, when P is excessively contained, sheet breakage may occur, which may reduce productivity, and thus, P may be controlled to be added in an amount of 0.07% or less.

In addition, Sb is effective in controlling an oxide layer inside the steel sheet to be thin. Sn also partially plays such a role, but the effect thereof may be smaller than that of Sb.

In addition, Sn contained in the steel sheet may be intentionally added within the range suggested in an exemplary embodiment of the present invention, and may be present in a trace in the steelmaking process.

Meanwhile, when a coiling temperature (CT) is increased to secure the magnetism of the steel sheet, the content of Sb and/or Sn may be precisely controlled according to [Expression 3] or [Expression 4]. As described above, the content of Sb/Sn is precisely controlled according to the coiling temperature, such that the oxide layer inside the steel sheet may be appropriately controlled.

$${0.000165}^{*} C T - 0.085 < \{ 1 / {3}^{⋆} [ Sn ] + [ Sb ] \} < 0 \text{.13} \qquad [ Expression 3 ]$$

$${0.000165}^{*} C T - 0.0934 < [ Sb ] < 0.05 \qquad [ Expression 4 ]$$

(Wherein [Sn] and [Sb] are wt % of Sn and Sb, respectively, and CT is an average coiling temperature at a length of 30% of the total length located in the center in a length direction during the hot rolling.)

As can be seen from [Expression 3] and [Expression 4], as the coiling temperature increases, a depth of the oxide layer inside the steel sheet may increase, but in order to suppress this, it is required to relatively control the content of Sb/Sn. In terms of controlling the depth of the oxide layer inside the steel sheet, the effect of Sb is superior to that of Sn. When the content of Sb is greater than [0.000165*CT−0.0934] of [Expression 4] and when the value of [⅓*[Sn]+[Sb]] is greater than [0.000165*CT−0.0934] of [Expression 3] in a complex manner of Sn/Sb, the depth of the oxide layer inside the steel sheet may be controlled to 7 μn or less.

However, when the contents of Sb and Sn are excessive, the adhesion of the product coating may be deteriorated, and therefore, Sn may be limited to 0.05 wt % or less, and an upper limit value of Sn in [Expression 3] may be limited to 0.13.

The non-oriented electrical steel sheet according to an exemplary embodiment of the present invention may further contain other unavoidably included elements in addition to the above components. For example, elements such as Zr, Mo, and V are elements that form strong carbides or nitrides in the steel sheet, and therefore, it is preferable not to contain these elements as much as possible, and even when these elements are added, it is preferable to control each of these elements to be contained in an amount of 0.05 wt % or less.

The unavoidable impurities refer to impurities that are intentionally added or unavoidably incorporated during the process of steelmaking and manufacturing a non-oriented electrical steel sheet. Since the unavoidable impurities are widely known, detailed descriptions are omitted. In addition, in an exemplary embodiment of the present invention, the addition of elements other than the alloy components described above is not excluded, and various elements may be contained within a range in which the technical spirit of the present invention is not impaired. In a case where additional elements are further contained, these additional elements are contained by replacing the balance of Fe.

Hereinafter, the reason why the magnetism of the steel sheet is improved, the surface properties are improved, and a magnetic deviation between positions of the steel sheet is eliminated in the method for manufacturing a non-oriented electrical steel sheet according to an exemplary embodiment of the present invention even though hot-rolled sheet annealing is omitted will be first described, and then the manufacturing method according to an exemplary embodiment of the present invention will be described.

First, the results of examining the hot rolling conditions for the component system in which phase transformation occurs during hot rolling will be described.

The slab is reheated for hot rolling, and in this case, the slab reheating temperature should be high enough for hot rolling. However, when the slab reheating temperature is too high, all sulfides are re-dissolved in the steel sheet and finely precipitated in the subsequent hot rolling and annealing processes, such that grain growth may be inhibited and magnetism may be deteriorated.

Therefore, in order to coarsen sulfides, it is preferable to reheat the slab at a temperature at which sulfides may be precipitated as much as possible, but when the temperature is too low, hot rolling productivity is reduced due to a decrease in rolling temperature, such that it is difficult to obtain a desired microstructure after hot rolling.

Therefore, as for the slab reheating temperature, a relationship between an equilibrium precipitation amount (MnS_sRT) of sulfides at the slab reheating temperature, that is, MnS, and a maximum precipitation amount (MnS_Max) of MnS needs to satisfy the condition of [Expression 5].

$${MnS\_}_{SRT} / {MnS\_}_{Max} \geq 0.6 \qquad [ Expression 5 ]$$

(Wherein MnS_sRT represents an equilibrium precipitation amount of MnS and MnS_Max represents a maximum precipitation amount of MnS.)

The present inventors have obtained the result that, when the slab reheating temperature is maintained at a temperature that satisfies [Expression 5] for 1 hour or longer, sulfides are coarsened, which is sufficient to improve the magnetism of the steel sheet.

In addition, in order to secure a recrystallized structure after hot rolling, it is required to perform the reheating of the slab in an austenite single-phase region. To this end, the present inventors have derived a result that the slab reheating temperature (SRT) needs to satisfy the following relational expression of [Expression 6].

$$S R T \geq A 1 + 150 ° C . \qquad [ Expression 6 ]$$

(Wherein SRT represents a slab reheating temperature, and Al represents an equilibrium temperature at which 100% of austenite is transformed into ferrite.)

It may be appreciated that, when the reheating of the slab is not performed at the heating temperature in the austenite single-phase region, a structure that does not undergo phase transformation is formed, such that it is not easy to secure a recrystallized structure after subsequent hot rolling, and when the slab is reheated in a state in which the relational expression of [Expression 6] is not satisfied, the phase transformation ends too early and the fraction of the recrystallized structure is rapidly decreased after hot rolling.

Meanwhile, in order to omit the hot-rolled sheet annealing, it is possible to secure the same excellent magnetism of the manufactured steel sheet as when the hot-rolled sheet annealing is performed by treatment such as increasing the hot rolling temperature during hot rolling and the coiling temperature or slightly increasing reduction heat of a subsequent rolling mill during hot rolling, but this may result in affecting surface properties such as stripes on the surface of the steel sheet.

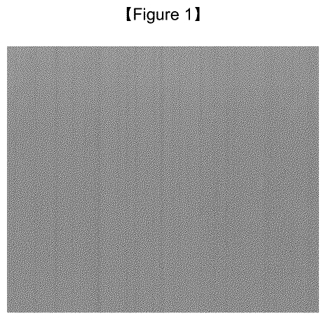

FIG. 1 is a photograph of stripes formed on a surface of a steel sheet manufactured by omitting the hot-rolled sheet annealing and increasing the hot rolling temperature and coiling temperature.

In FIG. 1, the direction from the bottom to the top of the photograph is a rolling direction.

When the steel sheet is manufactured by omitting the hot-rolled sheet annealing and increasing the hot rolling temperature and coiling temperature as described above, long stripes are formed in the rolling direction, and when a difference in heights of the stripes is evaluated in a direction perpendicular to the rolling direction, a concavo-convex shape is generated, which is confirmed as a kind of surface defect.

When a difference in heights on a cross section of the stripe portion in the direction perpendicular to the rolling direction is examined in FIG. 1, a difference in heights in the form protruding upward from a peripheral height is observed. However, when a difference in heights in the rolling direction in an area where such stripes are generated is examined, there is no specific tendency in the difference in heights.

As a result of investigating the cause of the stripe defect, the inventors of the present invention have confirmed that the stripe defect is closely related to a change of the inner oxide layer during hot rolling.

Among the components of the non-oriented electrical steel sheet, elements such as Si, Al, and Mn are more easily oxidized than iron, and when these elements are increased, oxidation easily occurs, and in particular, an oxide layer is formed inside the steel sheet.

The shape of the inner oxide layer of the steel sheet in this case will be described. When a portion where the oxide layer is entirely covered outside a metal matrix layer is called an outer oxide layer, the oxide layers are embedded toward a metal matrix structure in a direction of the metal matrix structure at a metal/oxide layer interface or the oxide layer present around a grain boundary is called an inner oxide layer.

When an inner oxide layer or an oxide layer formed along the grain boundary is formed in the steel sheet, during pickling before cold rolling, pickling may occur along the oxide layer, such that a non-uniform pickled surface may be formed, or long concavo-convex portions may be formed in the length direction due to the influence during cold rolling.

In general, since the inner oxide layer is formed to 5 μm or less when the coiling temperature is low during hot rolling, the inner oxide layer is sufficiently removed, and thus, there is no major problem. However, when the contents of easily oxidizable elements such as Si, Al, and Mn are high and the coiling temperature is high, the depth of the inner oxide layer inside the steel sheet may be increased and may also be non-uniform. This causes surface defects.

Therefore, as for these surface defects, when the composition of the steel sheet is within the ranges of 1.5 to 3.0% of Si, 0.0001 to 0.7% of Al, and 0.4 to 1.5% of Mn, and when the hot rolling temperature and the coiling temperature are increased, the generation of such stripes increases. Therefore, in order to remove these surface defects, it is required to utilize segregation elements.

Accordingly, the inventors of the present invention confirmed the formation process of the inner oxide layer according to the coiling temperature in the steel sheet having the contents of Si, Al, and Mn in the ranges as in an exemplary embodiment of the present invention.

As a result, when the coiling temperature is a low temperature of 630° C., an outer oxide layer having a dark color is formed the outside of the steel sheet, and an oxide layer of about 10 μm is formed along the grain boundary under the surface of the steel sheet.

In addition, when the coiling temperature is slightly increased to 680° C., along with the oxide layer formed along the grain boundary of the steel sheet, an inner oxide layer in the form with black dots is present right below the interface between the outer oxide layer and the inner oxide layer. In addition, a depth of the inner oxide layer formed along the grain boundary is about 10 μm or more, and a depth of the inner oxide layer in the grain boundary is about 6 to 7 μm.

Then, when the coiling temperature is increased to 750° C., the inner oxide layer of the steel sheet is formed up to about 30 μm, and in this case, surface defects are present to the extent that it is difficult to dissolve the formed inner oxide layer during the pickling process.

There are conditions in which surface defects are likely to occur in the component system and process conditions of the steel sheet designed to secure magnetism without the hot-rolled sheet annealing as described above, and thus, a method for solving this problem is required.

The inventors of the present invention suggest a composition system and manufacturing process conditions in order to eliminate these surface defects. As one of the methods, there is suggested a method of increasing the reduction amount at the subsequent stage of the hot rolling process and/or allowing segregation elements to be contained in the composition of the steel sheet.

As an exemplary embodiment for improving the surface properties, when the method of increasing the reduction amount at the subsequent stage of the hot rolling process and allowing segregation elements to be contained in the composition of the steel sheet is applied, it is confirmed that the inner oxide layer of the steel sheet is suppressed to about 3 μm or the inner oxide layer is hardly formed.

The inventors of the present invention considered that the cause of the concavo-convex defects due to the stripes of the steel sheet is a difference in grain phases, and in this case, a difference in stripes is observed in the texture of the concavo-convex and non-concavo-convex portions. However, as in an exemplary embodiment of the present invention, when the composition and manufacturing process of the steel sheet, for example, hot rolling conditions are controlled, it is considered that such a difference does not appear, and no change in the texture appears. That is, in the concavo-convex defects caused by these stripes, a change in {100} and {110} fractions of the concavo-convex and non-convex portions of the texture of the grain is considered to be less than 10%.

As described above, the phase transformation phenomenon during hot rolling and the process conditions of hot rolling are controlled in the non-oriented electrical steel sheet, such that a hot-rolled crystallized structure is secured, coarsening of sulfides is also achieved, formation of an inner oxide layer is suppressed, and a recrystallized structure in the hot-rolled sheet structure is increased. Therefore, according to an exemplary embodiment of the present invention, it is possible to provide a non-oriented electrical steel sheet having excellent magnetism and surface properties of the steel sheet without performing the hot-rolled sheet annealing.

Meanwhile, when a hot-rolled sheet that is not subjected to hot-rolled sheet annealing is manufactured into a coil shape, a magnetic deviation occurs in the width direction or the length direction, and this deviation appears larger than that in the case of performing the hot-rolled sheet annealing.

In general, when the slab is reheated, a deviation in physical properties of the manufactured hot-rolled sheet coil between positions occurs depending on a position of a skid device of a heating furnace. In addition, rough rolling and finishing rolling are sequentially performed in the hot rolling, in a state where the coil is at a high temperature immediately before the finishing rolling, a front end of the coil is immediately subjected to finishing rolling, but a rear end of the coil stays at a temperature immediately before the finishing rolling for a long time while the front end of the coil is rolled, which causes a difference in the structure or precipitate of the steel sheet. This difference becomes larger as the number of finely precipitated precipitates after re-dissolution of some elements during hot rolling increases.

In addition, even when coiling is performed in the hot rolling, a difference in cooling rate occurs depending on a position of the coil, resulting in a difference in the structure of the manufactured hot-rolled sheet. This difference minimizes this deviation when the hot-rolled sheet is annealed. However, when the hot-rolled sheet annealing is omitted, a method for minimizing this deviation should be considered.

Therefore, a method for minimizing this deviation without performing the hot-rolled sheet annealing is confirmed by measuring a deviation in iron loss in the width direction and the length direction of the entire coil while changing the hot rolling process conditions of the present invention.

That is, the inventors of the present invention suggested that it is required to secure a component system capable of undergoing austenite phase transformation during reheating of the hot-rolled sheet and conditions for reheating the hot-rolled sheet in order to obtain magnetic properties comparable to or superior to those in the case where the hot-rolled sheet annealing is performed in a steel sheet that is not subjected to hot-rolled sheet annealing in advance, and also suggested a method for controlling the oxide layer inside the steel sheet in order to secure a relatively high coiling temperature and prevent stripe defect on the surface. In addition to this, the inventors of the present invention suggested a method for reducing the magnetic deviation between positions of the coil.

First, as this method, a method for controlling the coiling temperature differently in the length direction is suggested in order to prevent the difference in cooling rate during coiling after hot rolling.

When the hot-rolled sheet is coiled into a coil, the cooling rate is fast in an outer coiled portion and the innermost coiled portion, and therefore, even when the coiling temperatures are controlled to be the same as each other, the time that the temperature is maintained around the coiling temperature after coiling is relatively small compared to a middle coiled portion. When the innermost coiled portion and the outer coiled portion are compared to the middle coiled portion, relatively deteriorated iron loss appears due to this difference.

However, the outer coiled portion is maintained at a high temperature immediately before finishing rolling for a long time, such that a time for fine precipitates to grow is secured, and thus, a degree of deterioration of magnetism is low, but the innermost coiled portion is maintained for a short time during coiling without this effect, and therefore, a way to offsetting this is required.

Therefore, in an exemplary embodiment of the present invention, it is confirmed that the deviation may be reduced when the coiling temperature of the inner coiled portion, that is, the front end of the hot-rolled sheet during coiling is maintained to be higher than the average temperature of the middle coiled portion by 20° C. or more.

In general, the front end is partially cut and removed in the process during hot rolling. Therefore, it is advantageous to reduce the deviation when the temperature at a position corresponding to about 5% of the total length is maintained at 20° C. or higher than the average temperature at a position corresponding to about 30% to 50% of the total length located in the center. More preferably, it is preferable to maintain this temperature at 30° C. or higher.

As an application length, it is preferable to apply a length of 5% or more of the total length, and the effect may be excellent even when the temperature is higher than that of the center up to a length of about 20% of the total length. It is presumed that an increase in coiling temperature of the front end of the coil may reduce the amount of cooling water sprayed to cool the hot-rolled sheet, may prevent overcooling of the edge in the width direction, and may reduce cooling of the center portion, and as a result, a deviation in width direction is also reduced.

Another cause of the magnetic deviation between the positions of the coil may be fine precipitates that are re-dissolved during slab reheating and then re-precipitated during hot rolling. That is, the deviation may be caused because there is no process in which fine precipitates are re-precipitated during hot rolling and are coarsened during hot-rolled sheet annealing.

In an exemplary embodiment of the present invention, when the slab is reheated, a process of securing 100% of a fraction of austenite and then performing phase transformation is performed, a coarse structure of the slab becomes relatively small grains, which prevents a structure from being difficult to be recrystallized at a low temperature.

To this end, the slab is preferably heated to SRT≥A1+150° C. as shown in [Expression 6]. However, as described above, in terms of precipitates, as the slab heating temperature increases, the amount of precipitates re-dissolved increases and the amount of fine precipitates increases, and therefore, the slab heating needs to be controlled.

In order to heat the entire slab to the temperature of [Expression 6], when the slab is charged into a heating furnace heated to this temperature at once, both ends of the slab are overheated and heated to a relatively high temperature, and fine precipitates may increase.

Therefore, in the heating of the slab, when the slab is initially heated to a temperature lower than a target temperature by 50° C. or more and then the slab is heated to the target temperature, the both ends of the slab, that is, the front end and the rear end, and the edge in the width direction are close to a surface receiving heat during hot rolling, which may cause a risk of overheating compared to the center portion. Therefore, an increase of fine precipitates in these portions may be prevented by reducing such a risk.

In this way, it is possible to reduce the deviation in iron loss in the length direction and the width direction of the coil. In addition, in such a slab heating furnace, the temperature may be set for each step without separating the regions for each step.

In addition, it is more preferable that the maximum SRT temperature is as low as possible in order to generally reduce the increase in some elements re-dissolved in the slab, but in order to secure the austenite grain phase, it is advantageous to increase the reheating temperature, and therefore, at the last stage, when the reheating temperature is increased, but the holding time is set to be shorter than that in the previous stage of the last stage, the heating temperature (SRT2) in the previous stage, that is, the previous stage of the last stage, is set to A3 temperature+70° C. or lower, the heating is performed at a temperature that satisfies A1+120° C. or higher, and the temperature is controlled to satisfy the heating temperature SRT_max≥A1+150° C. at the last stage, the deviation between the positions of the coil may be reduced.

(Wherein SRT_max represents the highest temperature among slab reheating temperatures (SRT) in [Expression 6].)

In addition, when the temperature immediately before finishing rolling is increased while reducing fine precipitates, growth of fine precipitates may be induced, which may help to reduce the deviation. In finishing rolling in the hot rolling, when a temperature just before the start of the finishing rolling in the hot rolling is set to a temperature of A1−50° C. or higher, the deviation may be reduced.

However, when this temperature is too high, it is preferable to start the finishing rolling at a temperature of A1+40° C. or lower because a deviation in stripes may occur due to rolling at a dual phase region until rear end pass during the finishing rolling. It is more preferable to start the finishing rolling at a temperature of A1+20° C. or lower.

In addition, when the hot-rolled sheet is coiled into a coil shape and then the coiled hot-rolled sheet is cooled while being covered with a heat retention cover, the cooling rate of the outer coiled portion and the inner coiled portion may be slowed down, and a difference in cooling rate in the width direction is also reduced, such that the deviation in iron loss may be reduced.

Hereinafter, a method for manufacturing a non-oriented electrical steel sheet according to an exemplary embodiment of the present disclosure will be described.

A method for manufacturing a non-oriented electrical steel sheet according to an exemplary embodiment of the present invention includes: in a steelmaking process, preparing a slab containing, by wt %, 0.005% or less (excluding 0%) of C, 1.5 to 3.0% of Si, 0.4 to 1.5% of Mn, 0.005% or less (excluding 0%) of S, 0.0001 to 0.7% of Al, 0.005% or less (excluding 0%) of N, 0.005% or less (excluding 0%) of Ti, 0.001 to 0.02% of Cu, 0.01 to 0.05% of Sb, 0.001 to 0.1% of Sn, and 0.005 to 0.07% of P, in which contents of Si, Mn, and Al satisfy the following [Expression 1] and contents of Sb, Sn, and P satisfy the following [Expression 2], the slab containing a balance of Fe and unavoidable impurities; reheating the slab; hot rolling the slab to manufacture a hot-rolled sheet; coiling the hot-rolled sheet; cold rolling the coiled hot-rolled sheet to manufacture a cold-rolled sheet; and subjecting the cold-rolled sheet to final annealing.

Hereinafter, each step will be described in detail.

First, the preparing of the slab will be described. Since the reason for limiting the constituent elements in the slab is the same as the reason for limiting the composition of the non-oriented electrical steel sheet described above, repeated descriptions will be described. The composition of the slab is not substantially changed during manufacturing processes such as hot rolling, cold rolling, and final annealing, which will be described below, and thus, the composition of the slab is substantially the same as the composition of the non-oriented electrical steel sheet.

Before the manufacturing of the hot-rolled sheet, the slab may be reheated.

The reheating of the slab is performed at a slab reheating temperature (SRT), that is, a temperature that satisfies [Expression 5: MnS_{SRT}/MnS_{Max}≥0.6], which is a relational expression between MnS_{SRT} representing the equilibrium precipitation amount of MnS and MnS_{Max} representing the maximum precipitation amount of MnS in steel. When the slab reheating temperature is too high, MnS is re-dissolved and finely precipitated during the hot rolling and annealing processes, and when the slab reheating temperature is too low, it is advantageous to coarsen MnS, but hot rolling properties are deteriorated, and it is difficult to secure a recrystallized structure after hot rolling due to not securing a sufficient phase transformation section.

In addition, the reheating of the slab should be performed in the austenite single-phase region, and the total reheating time may be at a level commonly used, but the reheating may be performed at least 1 hour or longer at a temperature in the austenite single-phase region. The total slab reheating time including the total heating is preferably 100 minutes or longer, and more preferably 180 minutes or longer.

When the slab heating time is too long, the productivity is deteriorated, and recrystallization is difficult because the structure is too coarse, and therefore, an upper limit thereof is 500 minutes. The slab heating time is required for coarsening of sulfides and is required for coarsening of the recrystallized structure after hot rolling by coarsening the grain size of austenite before hot rolling.

In addition, the slab reheating temperature may be a temperature that satisfies the relational expression [Expression 6: SRT≥A1+150° C.] in consideration of the equilibrium temperature at which 100% of austenite is transformed into ferrite. This is to sufficiently secure a recrystallized structure after hot rolling by securing a sufficient temperature range in which phase transformation may occur during hot rolling.

Meanwhile, in order to reduce the magnetic deviation in the width direction and the length direction in the entire coil of the manufactured steel sheet, it is preferable to heat the slab stepwise when heating the slab.

That is, when reheating the slab, 100% of the fraction of austenite is secured and phase transformation is undergone, such that a coarse structure of the slab is made into relatively small crystal grains, which prevents the formation of a structure that is difficult to recrystallize at a low temperature.

To this end, it is preferable to reheat the slab to a temperature that satisfies [Expression 6: SRT≥A1+150° C.].

However, in terms of the precipitates described above, as the slab reheating temperature increases, the amount of elements re-dissolved increases, resulting in an increase in the amount of fine precipitates, and therefore, it is required to control the slab reheating method. In order to heat the entire slab to the temperature that satisfies [Expression 6], when the slab is charged into the heating furnace heated to this temperature at once, both ends of the slab are overheated and heated to a relatively high temperature, and fine precipitates may increase.

Therefore, in the reheating of the slab, when the slab is heated in two or more stages or three or more stages, the slab is heated to a temperature lower than the target temperature by 50° C. or more (SRT_max−50) at the first stage (SRT1), and then, the slab is heated to the target temperature, both ends of the slab, that is, the front end and the rear end and the edge in the width direction are close to the surface receiving heat during hot rolling, which may cause a risk of overheating compared to the center portion. Therefore, an increase of fine precipitates in these portions may be prevented by reducing such a risk. In this way, it is possible to reduce the deviation in iron loss in the length direction and the width direction of the coil.

In addition, in order to reduce the increase in the amount of overall components re-dissolved, it is more advantageous that the maximum slab reheating temperature is as low as possible. In order to secure the austenite phase, it is advantageous to increase the reheating temperature, and therefore, at the last stage, when the reheating temperature is increased, but the holding time is set to be shorter than that in the previous stage of the last stage, the heating temperature (SRT2) in the previous stage, that is, the previous stage of the last stage, is set to A3 temperature+70° C. or lower, the heating is performed at a temperature that satisfies A1+120° C. or higher, and the temperature is controlled to satisfy the heating temperature SRT_max≥A1+150° C. at the last stage, the deviation may be reduced.

(Wherein SRT_max represents the highest temperature among slab reheating temperatures (SRT) in [Expression 6].)

Meanwhile, in the hot rolling, when the fine precipitates in the steel sheet are reduced and the temperature immediately before finishing rolling is increased in finishing rolling in the hot rolling, growth of fine precipitates may be induced, which may be advantageous in reducing magnetic deviation. A temperature just before the start of the finishing rolling in the hot rolling is set to a temperature of A1−50° C. or higher, the deviation may be reduced. However, when the finishing rolling temperature is too high, it is preferable to start the finishing rolling at a temperature of A1+40° C. or lower because a deviation in stripes may occur due to rolling at a dual phase region until rear end pass during the finishing rolling. It is more preferable to start the finishing rolling at a temperature of A1+20° C. or lower.

In addition, in order to secure a recrystallization fraction during hot rolling, it is required to control a reduction ratio in the last two rolls in the finishing rolling. In the hot rolling, finishing rolling is performed in several rolls (for example, 6 or 7 rolls), and the recrystallization fraction in the hot-rolled sheet may be increased by slightly increasing the reduction ratio of the last two rolls. Therefore, it is preferable to set a reduction ratio of a roll immediately before the last roll to 21% or more. In addition, when a reduction ratio of the last roll is set to 13% or more, it is advantageous to increase the recrystallization fraction.

In the finishing rolling of the hot rolling, since the rolling temperature in the last two rolls is the lowest, when the reduction ratio is too high, problems may occur in rolling, and therefore, it is preferable that the total reduction ratio in these two rolls does not exceed 60%.

The hot-rolled sheet hot-rolled under the above conditions is coiled into a coil shape. In this case, a coiling temperature is preferably 650 to 800° C.

When the coiling temperature of the hot-rolled sheet is too high, a fraction of recrystallized grains in the hot-rolled sheet may be greatly increased, and therefore, in order to obtain this effect in the process in which the hot-rolled sheet annealing is omitted, the coiling temperature is preferably set to 650° C. or higher. However, when the coiling temperature is high, an oxide layer is excessively formed, the coiling temperature is preferably set to 800° C. or lower, and more preferably 750° C. or lower.

The coiling is preferably performed according to the following [Expression 7] representing that a temperature at a front end of the coil is higher than a temperature at a middle portion of the coil by 20° C. or more.

(Maximum coiling temperature at length from start point to point of 5% of total length in coil length direction)≥(average coiling temperature at length of 30% to 50% of total length in coil length direction)+20° C. [Expression 7]

As described above, the magnetic deviation in the width direction and the length direction of the coil may be further reduced by imparting a deviation in temperatures of the frond end and the middle portion of the coil.

In the hot-rolled sheet hot-rolled under the above conditions, it is preferable to control a thickness of the inner oxide layer formed inside the steel sheet to 7 μm or less. In order to prevent the presence of surface defects in the final electrical steel sheet product, it is preferable to set the thickness of the inner oxide layer formed during hot rolling to 7 μm or less. More preferably, the thickness of the inner oxide layer is set to 5 μm or less. Controlling the thickness of the inner oxide layer may reduce the thickness of the oxide layer to be removed in a subsequent pickling process, such that a real yield may be increased, and the occurrence of stripes formed on the surface may be prevented.

In addition, the hot-rolled sheet manufactured under the above conditions may be coiled into a coil shape, put into a cooling facility during cooling, and then cooled while being covered with a heat retention cover. As described above, when the hot-rolled sheet is covered with the heat retention cover and then cooled, the cooling rate between the outer coiled portion and the inner coiled portion of the coil may be slowed down, and the difference in cooling rate in the width direction may be reduced, resulting in a reduction in deviation in iron loss.

Next, the hot-rolled sheet is pickled, and the pickled hot-rolled sheet is subjected to cold rolling to obtain a predetermined sheet thickness. In this case, the cold-rolled sheet subjected to the cold rolling may be 0.10 mm to 0.70 mm.

The final cold-rolled sheet subjected to the cold rolling is subjected to final annealing. As described above, in the process of annealing the cold-rolled sheet, the annealing temperature is preferably 850 to 1,100° C. because iron loss is related to the grain size in the case of the non-oriented electrical steel sheet. When the final annealing temperature is lower than 850° C., the grains are too fine and hysteresis loss increases, and on the other hand, when the final annealing temperature exceeds 1,100° C., the phase transformation generation fraction increases depending on the component system, and thus, iron loss may be deteriorated due to grain refinement. Therefore, the temperature during the final annealing is preferably in a range of 850 to 1,100° C., and more preferably in a range of 900 to 1,050° C.

Thereafter, the method may further include forming an insulating layer. Since a method for forming an insulating layer is widely known in the technical field of the non-oriented electrical steel sheet, a detailed description thereof will be omitted.

In the non-oriented electrical steel sheet manufactured according to an exemplary embodiment of the present invention described above, the number of (Mn, Cu)S of 0.5 μm or less inside the steel sheet per area is 1/μm³ or less, a number ratio (Fcount) of (Mn, Cu)S having a size of 0.05 μm or more to (Mn, Cu)S of 0.5 μm or less is 0.2 or more, an area ratio (Farea) of (Mn, Cu)S having a size of 0.05 μm or more is 0.5 or more, and a product of the number ratio (Fcount) and the area ratio (Farea) (Fcount×Farea) is 0.15 or more.

In addition, in the non-oriented electrical steel sheet manufactured according to an exemplary embodiment of the present invention, when the center line of a surface height is drawn in a direction perpendicular to a rolling direction and measurement is performed in a length unit of 4 mm in the direction perpendicular to the rolling direction, a maximum height from the center line is 2.5 μm or less, and the number of concavo-convex defects having a height greater than a peripheral height and having a width of 0.5 μm or more in the direction perpendicular to the rolling direction and a size of 3 cm or more in the rolling direction is 1/cm or less per 10 cm in the direction perpendicular to the rolling direction.

In addition, a change in {100} and {110} fractions at different positions of the electrical steel sheet manufactured as described above is less than 10%, such that it is possible to manufacture a non-oriented electrical steel sheet having excellent magnetism even when hot-rolled sheet annealing is not performed.

The following examples illustrate the present invention in more detail. However, each of the following Examples is merely a preferred example of the present invention, and the present invention is not limited to the following Examples.

### Example 1

A steel ingot containing 0.002 wt % of C and 0.0021 wt % of N was manufactured with the composition shown in Table 1 by vacuum-melting.

For each specimen, the amount of Si, Mn, and Al was varied, and the effect of each of the amounts of Si, Mn, and Al added and control of the contents of Si, Mn, and Al specified in [Expression 1] on the magnetic properties of the steel sheet were examined. In addition, it was examined that, in the manufacturing process, how the amount of MnS precipitated according to the slab reheating temperature such as the equilibrium precipitation amount (MnS_{SRT}) and the maximum precipitation amount (MnS_{Max}) specified in [Expression 5] affected on the magnetism of the steel sheet. In addition, the effect of the contents of Sb, Sn, and P specified in [Expression 2] on the inner oxide layer and the surface defects was also examined.

The manufactured steel ingot was reheated at 1,150° C., hot-rolled to a thickness of 2.5 mm, and then coiled. The coiling temperatures of the respective specimens are shown in Table 1. As the coiling temperatures of steel type numbers A1 to 6 were changed to 630, 680, and 750° C., the steel type numbers A1 to 6 were indicated as additional numbers −1, −2, and −3, respectively.

In addition, the coiled hot-rolled sheet was pickled without hot-rolled sheet annealing, cold-rolled to a thickness of 0.50 mm, and then finally, subjected to final annealing. At this time, the final annealing was performed at a temperature of 900 to 1,050° C.

In each of the specimens prepared as described above, the number and distribution of inclusions after the final annealing were measured, and the depth of the inner oxide layer of the hot-rolled sheet and the surface properties of the final product sheet were also measured. In addition, the iron loss (W15/50) and magnetic flux density (B50) at the optimal temperature among the annealing temperatures were also measured. The results thereof are shown in Tables 2 and 3.

TABLE 1

| Steel | Si | Mn | Al | S | Sb | Sn | P | Ti | Cu | CT |
|---|---|---|---|---|---|---|---|---|---|---|
| type | (wt %) | (wt %) | (wt %) | (wt %) | (wt %) | (wt %) | (wt %) | (wt %) | (wt %) | temperature |
| A1-1 | 2.09 | 0.65 | 0.0061 | 0.0027 | 0 | 0.025 | 0.012 | 0.0022 | 0.006 | 630 |
| A2-1 | 2.05 | 0.64 | 0.0073 | 0.0027 | 0.009 | 0.025 | 0.009 | 0.0021 | 0.007 | 630 |
| A3-1 | 1.99 | 0.67 | 0.0009 | 0.0025 | 0.021 | 0.025 | 0.011 | 0.0021 | 0.011 | 630 |
| A4-1 | 2.02 | 0.65 | 0.0051 | 0.0027 | 0.028 | 0.025 | 0.012 | 0.0011 | 0.013 | 630 |
| A5-1 | 2.07 | 0.64 | 0.0012 | 0.0032 | 0.036 | 0.002 | 0.013 | 0.0013 | 0.009 | 630 |
| A6-1 | 2.01 | 0.67 | 0.0035 | 0.0026 | 0.041 | 0.025 | 0.011 | 0.0011 | 0.014 | 630 |
| A1-2 | 2.09 | 0.65 | 0.0061 | 0.0027 | 0 | 0.025 | 0.012 | 0.0022 | 0.006 | 680 |
| A2-2 | 2.05 | 0.64 | 0.0073 | 0.0027 | 0.009 | 0.025 | 0.009 | 0.0021 | 0.007 | 680 |
| A3-2 | 1.99 | 0.67 | 0.0009 | 0.0025 | 0.021 | 0.025 | 0.011 | 0.0021 | 0.011 | 680 |
| A4-2 | 2.02 | 0.65 | 0.0051 | 0.0027 | 0.028 | 0.025 | 0.012 | 0.0011 | 0.013 | 680 |
| A5-2 | 2.07 | 0.64 | 0.0012 | 0.0032 | 0.036 | 0.002 | 0.013 | 0.0013 | 0.009 | 680 |
| A6-2 | 2.01 | 0.67 | 0.0035 | 0.0026 | 0.041 | 0.025 | 0.011 | 0.0011 | 0.014 | 680 |
| A1-3 | 2.09 | 0.65 | 0.0061 | 0.0027 | 0 | 0.025 | 0.012 | 0.0022 | 0.006 | 750 |
| A2-3 | 2.05 | 0.64 | 0.0073 | 0.0027 | 0.009 | 0.025 | 0.009 | 0.0021 | 0.007 | 750 |
| A3-3 | 1.99 | 0.67 | 0.0009 | 0.0025 | 0.021 | 0.025 | 0.011 | 0.0021 | 0.011 | 750 |
| A4-3 | 2.02 | 0.65 | 0.0051 | 0.0027 | 0.028 | 0.025 | 0.012 | 0.0011 | 0.013 | 750 |
| A5-3 | 2.07 | 0.64 | 0.0012 | 0.0032 | 0.036 | 0.002 | 0.013 | 0.0013 | 0.009 | 750 |
| A6-3 | 2.01 | 0.67 | 0.0035 | 0.0026 | 0.041 | 0.025 | 0.011 | 0.0011 | 0.014 | 750 |
| A7 | 2.03 | 0.67 | 0.0031 | 0.0027 | 0.09 | 0.025 | 0.051 | 0.002 | 0.015 | 680 |
| A8 | 2.08 | 0.66 | 0.0032 | 0.0025 | 0.03 | 0.13 | 0.048 | 0.0017 | 0.012 | 680 |
| A9 | 2.06 | 0.3 | 0.0015 | 0.0032 | 0 | 0 | 0 | 0.0019 | 0.006 | 680 |

TABLE 2

| | [Expression | [Expression | Number per | | | | [Expression 3] | | [Expression |
|---|---|---|---|---|---|---|---|---|---|
| Steel | 1] | 5] | area | | | F_{count} × | 0.000165* CT- | [Expression 3] | 4] 0.000165* |
| type | 0.19 to 0.35 | ≥0.6 | (number/μm³) | F_{count} | Fₐᵣₑₐ | Fₐᵣₑₐ | 0.085 | 1/3[Sn] + [Sb] | CT-0.093394 |
| A1-1 | 0.216 | 0.862 | 0.82 | 0.43 | 0.71 | 0.31 | 0.0190 | 0.0083 | 0.0106 |
| A2-1 | 0.203 | 0.860 | 0.83 | 0.42 | 0.75 | 0.32 | 0.0190 | 0.0173 | 0.0106 |
| A3-1 | 0.315 | 0.856 | 0.79 | 0.45 | 0.7 | 0.32 | 0.0190 | 0.0293 | 0.0106 |
| A4-1 | 0.233 | 0.862 | 0.72 | 0.37 | 0.65 | 0.24 | 0.0190 | 0.0363 | 0.0106 |
| A5-1 | 0.284 | 0.882 | 0.87 | 0.42 | 0.75 | 0.32 | 0.0190 | 0.0367 | 0.0106 |
| A6-1 | 0.264 | 0.861 | 0.75 | 0.35 | 0.78 | 0.27 | 0.0190 | 0.0493 | 0.0106 |
| A1-2 | 0.216 | 0.862 | 0.82 | 0.43 | 0.71 | 0.31 | 0.0272 | 0.0083 | 0.0188 |
| A2-2 | 0.203 | 0.860 | 0.83 | 0.42 | 0.75 | 0.32 | 0.0272 | 0.0173 | 0.0188 |
| A3-2 | 0.315 | 0.856 | 0.79 | 0.45 | 0.7 | 0.32 | 0.0272 | 0.0293 | 0.0188 |
| A4-2 | 0.233 | 0.862 | 0.72 | 0.37 | 0.65 | 0.24 | 0.0272 | 0.0363 | 0.0188 |
| A5-2 | 0.284 | 0.882 | 0.87 | 0.42 | 0.75 | 0.32 | 0.0272 | 0.0367 | 0.0188 |
| A6-2 | 0.264 | 0.861 | 0.75 | 0.35 | 0.78 | 0.27 | 0.0272 | 0.0493 | 0.0188 |
| A1-3 | 0.216 | 0.862 | 0.82 | 0.43 | 0.71 | 0.31 | 0.0388 | 0.0083 | 0.0304 |
| A2-3 | 0.203 | 0.860 | 0.83 | 0.42 | 0.75 | 0.32 | 0.0388 | 0.0173 | 0.0304 |
| A3-3 | 0.315 | 0.856 | 0.79 | 0.45 | 0.7 | 0.32 | 0.0388 | 0.0293 | 0.0304 |
| A4-3 | 0.233 | 0.862 | 0.72 | 0.37 | 0.65 | 0.24 | 0.0388 | 0.0363 | 0.0304 |
| A5-3 | 0.284 | 0.882 | 0.87 | 0.42 | 0.75 | 0.32 | 0.0388 | 0.0367 | 0.0304 |
| A6-3 | 0.264 | 0.861 | 0.75 | 0.35 | 0.78 | 0.27 | 0.0388 | 0.0493 | 0.0304 |
| A7 | 0.269 | 0.866 | 0.75 | 0.32 | 0.74 | 0.24 | 0.0272 | 0.0983 | 0.0188 |
| A8 | 0.258 | 0.854 | 0.71 | 0.35 | 0.7 | 0.25 | 0.0272 | 0.0733 | 0.0188 |
| A9 | 0.131 | 0.746 | 0.81 | 0.2 | 0.57 | 0.11 | 0.0272 | 0.0000 | 0.0188 |

In Table 2, [Expression 1] represents 0.19≤[Mn]/([Si]+150×[Al])≤0.35, [Expression 5] represents MnS_{SRT}/MnS_{Max}≥0.6, Fcount represents the number of (Mn,Cu)S having a size of 0.05 μm or more among (Mn,Cu)S of 0.5 μm or less, and Farea represents an area ratio of (Mn,Cu)S having a size of 0.05 μm or more to (Mn,Cu)S of 0.5 μm or less.

TABLE 3

| | | | | | | | | Change in | |
|---|---|---|---|---|---|---|---|---|---|
| | | Stripe | | | | | | texture | |
| | Oxide | maximum | | | | Magnetic | | fractions at | |
| | layer | height | Degree | | Iron loss, | flux | | different | |
| Steel | thickness | [μm] | of stripe | Number of stripes | W15/50 | density, | Coating | positions | |
| type | [μm] | (1) | defect | (2) | (W/Kg)(3) | B₅₀ (T) (4) | adhesion | [%] | Reference |
| A1-1 | 7.4 | 2.8 | Poor | 4 | 3.73 | 1.65 | Good | 5% or less | Comparative |
| | | | | | | | | | Example |
| A2-1 | 5.5 | 1.2 | Good | Good (1 or fewer) | 3.52 | 1.66 | Good | 5% or less | Comparative |
| | | | | | | | | | Example |
| A3-1 | 3.1 | 1.3 | Good | Good (1 or fewer) | 3.45 | 1.67 | Good | 5% or less | Comparative |
| | | | | | | | | | Example |
| A4-1 | 3.9 | 1.1 | Good | Good (1 or fewer) | 3.42 | 1.68 | Good | 5% or less | Comparative |
| | | | | | | | | | Example |
| A5-1 | 3.3 | 1.1 | Good | Good (1 or fewer) | 3.48 | 1.66 | Good | 5% or less | Comparative |
| | | | | | | | | | Example |
| A6-1 | 1.6 | 1 | Good | Good (1 or fewer) | 3.45 | 1.67 | Good | 5% or less | Comparative |
| | | | | | | | | | Example |
| A1-2 | 10.5 | 4.5 | Poor | 5.3 | 3.28 | 1.73 | Good | 5% or less | Comparative |
| | | | | | | | | | Example |
| A2-2 | 8.5 | 3.9 | Poor | 4.6 | 3.23 | 1.73 | Good | 5% or less | Comparative |
| | | | | | | | | | Example |
| A3-2 | 3.4 | 1.9 | Good | Good (1 or fewer) | 3.18 | 1.74 | Good | 5% or less | Inventive |
| | | | | | | | | | Example |
| A4-2 | 3.2 | 1.1 | Good | Good (1 or fewer) | 3.04 | 1.74 | Good | 5% or less | Inventive |
| | | | | | | | | | Example |
| A5-2 | 3.1 | 0.8 | Good | Good (1 or fewer) | 3.02 | 1.72 | Good | 5% or less | Inventive |
| | | | | | | | | | Example |
| A6-2 | 1.3 | 0.9 | Good | Good (1 or fewer) | 3.13 | 1.74 | Good | 5% or less | Inventive |
| | | | | | | | | | Example |
| A1-3 | 32.1 | 4.7 | Poor | 8.1 | 3.05 | 1.74 | Good | 5% or less | Comparative |
| | | | | | | | | | Example |
| A2-3 | 23.2 | 3.5 | Poor | 7.2 | 3.03 | 1.74 | Good | 5% or less | Comparative |
| | | | | | | | | | Example |
| A3-3 | 12.8 | 2.8 | Poor | 5.4 | 2.95 | 1.74 | Good | 5% or less | Comparative |
| | | | | | | | | | Example |
| A4-3 | 9.1 | 2.7 | Poor | 4.4 | 2.97 | 1.74 | Good | 5% or less | Comparative |
| | | | | | | | | | Example |
| A5-3 | 4.2 | 1.3 | Good | Good (1 or fewer) | 2.95 | 1.73 | Good | 5% or less | Inventive |
| | | | | | | | | | Example |
| A6-3 | 0.4 | 1.1 | Good | Good (1 or fewer) | 2.99 | 1.72 | Good | 5% or less | Inventive |
| | | | | | | | | | Example |
| A7 | 0.6 | 0.8 | Good | Good (1 or fewer) | 3.52 | 1.7 | Poor | 5% or less | Comparative |
| | | | | | | | | | Example |
| A8 | 1.9 | 0.8 | Good | Good (1 or fewer) | 3.65 | 1.7 | Poor | 5% or less | Comparative |
| | | | | | | | | | Example |
| A9 | 10.1 | 3.1 | Poor | 7.4 | 3.52 | 1.67 | Good | 14% | Comparative |
| | | | | | | | | | Example |

In Table 3, (1) “stripe” represents the stripe appearing on the surface layer of the specimen, and (2) “number of stripes” represents the number of stripes for 10 cm in the direction perpendicular to the rolling direction obtained by measuring the degree of stripe defect on the surface of the specimen.

In addition, in Table 3, (3) iron loss (W15/50) represents an average loss (W/kg) in the rolling direction and the direction perpendicular to the rolling direction when a magnetic flux density of 1.5 Tesla is induced at a frequency of 50 Hz.

In addition, (4) magnetic flux density (B50) represents a magnitude (Tesla) of a magnetic flux density induced when a magnetic field of 5,000 A/m is applied.

As shown in Tables 2 and 3, in the case where the contents of Si, Al, and Mn according to an exemplary embodiment of the present invention satisfied the conditions of [Expression 1] and MnS precipitates at the reheating temperature during hot rolling also satisfied the conditions of [Expression 5], the number of (Mn,Cu)S of 0.5 μm or less per area was 1/μm³ or less, the number ratio (Fcount) and the area ratio (Farea) of (Mn,Cu)S having a size of 0.05 μm or more to (Mn,Cu)S of 0.5 μm or less were 0.2 and 0.5 or more, respectively, and the product (Fcount×Farea) of the number ratio (Fcount) and the area ratio (Farea) was 0.15 or more. As a result, the iron loss W15/50 and the magnetic flux density B50 of the corresponding specimen were excellent.

In addition, in Table 1, when the coiling temperature (CT temperature) was 630° C., which was low, the iron loss and the magnetic flux density were not excellent overall. Meanwhile, the relationship between the segregation elements and the coiling temperature was found to be important in terms of the surface properties.

In the case where the coiling temperature satisfied the relationship of [Expression 3], the thickness of the inner oxide layer of the hot-rolled sheet was small, the concavo-convex portions of the corresponding specimen were good, and the number of defects was good.

Meanwhile, in the case where the contents of Sb, Sn, and P were significantly excessive, even when the surface stripe defect was good, but the adhesion and the magnetism were poor, or the productivity due to cracks was deteriorated.

Referring to the experimental examples, in the case where the conditions of [Expression 1] were well satisfied, there was no concavo-convex defects, or the change in {100} and {110} fractions satisfied less than 10% in the change in texture at different positions, but in the other cases where the conditions were out of the ranges of [Expression 1], the concavo-convex defects affected the change in texture. In addition, in the case where P, Sb, and Sn were not contained, the magnetism was deteriorated.

### Example 2

Next, the deviation in iron loss depending on the position in the width direction and the length direction of the steel sheet according to the changes in slab heating conditions and hot rolling conditions was confirmed.

The composition of the specimen used in the experiment was as follows.
Component 1 specimen: containing, by wt %, 2.01% of Si, 0.005% of Al, 0.61% of Mn, 0.01% of P, 0.03% of Sb, 0.0035% of S, 0.0025% of C, 0.0019% of N, 0.0011% of Ti, 0.01% of Cu, 0.01% of Sn, the balance of Fe and other unavoidable impurities
Component 2 specimen: containing, by wt %, 1.99% of Si, 0.007% of Al, 0.59% of Mn, 0.011% of P, 0.03% of Sb, 0.0038% of S, 0.0022% of C, 0.0019% of N, 0.0012% of Ti, 0.01% of Cu, 0.01% of Sn, the balance of Fe and other unavoidable impurities

Here, in the component 1 specimen, the Al temperature was 978° C., the A3 temperature was 1,103° C., the proportional content of Mn, Si, and Al according to [Expression 1] was 0.221, which was within the acceptable range of 0.19 to 0.35, the ½*Sn value according to [Expression 2] was 0.005, and the [Sb]+[P] value was 0.04, which satisfied the condition of [Expression 2].

In addition, in the component 2 specimen, the Al temperature was 984° C., the A3 temperature was 1,106° C., the proportional content of Mn, Si, and Al according to [Expression 1] was 0.194, which was within the acceptable range of 0.19 to 0.35, the ½*Sn value according to [Expression 2] was 0.005, and the [Sb]+[P] value was 0.041, which satisfied the condition of [Expression 2].

Slabs were manufactured with the compositions of the component 1 and component 2 described above, these slabs were reheated at different temperatures in two stage or three stages by setting the total residence time to 200 minutes, the reheated slabs were hot-rolled to a thickness of 2.5 mm, and the hot-rolled slabs were coiled into a coil shape.

As shown in Table 4, some coiled coils were cooled with or without a heat retention cover.

Then, the coiled hot-rolled sheet was pickled without hot-rolled sheet annealing and then cold-rolled to a thickness of 0.50 mm to manufacture a cold-rolled sheet. In addition, the cold-rolled sheet was subjected to final annealing. At this time, the final annealing was performed at a temperature of 980° C.

In the specimens prepared under the conditions as described above, the deviation in iron loss at different positions in the width direction and the length direction of the steel sheet was measured while changing the reheating conditions, the hot rolling conditions, and the coiling temperature conditions of each of the slabs as shown in Table 4.

TABLE 4

| | | | | | Finishing rolling | | Coiling temperature [° C.] | | |
|---|---|---|---|---|---|---|---|---|---|
| | | Slab heating furnace temperature | | | temperature [° C.] (1) | | | Center | Use of |
| | | [° C.] | | | Temperature | Temperature | Front end | portion | heat |
| | | | Second | Third | immediately | immediately | temperature | temperature | retention |
| | | First heating | heating | heating | before | after | in length | in length | cover |
| Steel | Used | region | region | region | finishing | finishing | direction | direction | after |
| type | component | temperature | temperature | temperature | rolling | rolling | (2) | (3) | coiling |
| B1 | Component 1 | 1150 | 1150 | 1150 | 950 | 880 | 680 | 680 | Not used |
| B2 | Component 1 | 1050 | 1150 | 1150 | 950 | 880 | 680 | 680 | Not used |
| B3 | Component 1 | 1050 | 1150 | 1170 | 975 | 915 | 680 | 680 | Not used |
| B4 | Component 1 | 1050 | 1150 | 1150 | 950 | 880 | 720 | 680 | Not used |
| B5 | Component 1 | 1050 | 1150 | 1170 | 975 | 915 | 720 | 680 | Not used |
| B6 | Component 1 | 1050 | 1150 | 1150 | 960 | 915 | 810 | 680 | Not used |
| B7 | Component 1 | 1050 | 1150 | 1150 | 963 | 882 | 600 | 600 | Not used |
| B8 | Component 2 | 1050 | 1140 | 1140 | 970 | 910 | 720 | 680 | Not used |
| B9 | Component 2 | 1050 | 1140 | 1140 | 930 | 850 | 720 | 680 | Not used |
| B10 | Component 2 | 1050 | 1200 | 1200 | 1030 | 940 | 720 | 680 | Not used |
| B11 | Component 2 | 1050 | 1140 | 1140 | 970 | 910 | 710 | 680 | Used |

In Table 4, (1) finishing rolling temperature represents the temperature immediately before and after the finishing rolling by tandem rolling after rough rolling, (2) front end temperature in length direction represents the temperature at a position corresponding to 5% of the length direction when the sheet is coiled into a coil shape, and (3) center portion temperature in length direction represents an average temperature at a position corresponding to a length of 30% of the total length of the coil.

In addition, the phase transformation temperatures related to A1 and A3 of each of the components 1 and 2 are shown in Table 5.

TABLE 5

| | Phase transformation temperature for each component [° C.] | | | | | | |
|---|---|---|---|---|---|---|---|
| Steel | | | A1 + | A3 temperature + | A1 + | A1 + | A1 + |
| type | A1 | A3 | 120° C. | 70° C. | 150° C. | 50° C. | 40° C. |
| B1 | 978 | 1103 | 1098 | 1173 | 1128 | 928 | 1018 |
| B2 | 978 | 1103 | 1098 | 1173 | 1128 | 928 | 1018 |
| B3 | 978 | 1103 | 1098 | 1173 | 1128 | 928 | 1018 |
| B4 | 978 | 1103 | 1098 | 1173 | 1128 | 928 | 1018 |
| B5 | 978 | 1103 | 1098 | 1173 | 1128 | 928 | 1018 |
| B6 | 978 | 1103 | 1098 | 1173 | 1128 | 928 | 1018 |
| B7 | 978 | 1103 | 1098 | 1173 | 1128 | 928 | 1018 |
| B8 | 984 | 1106 | 1104 | 1176 | 1134 | 934 | 1024 |
| B9 | 984 | 1106 | 1104 | 1176 | 1134 | 934 | 1024 |
| B10 | 984 | 1106 | 1104 | 1176 | 1134 | 934 | 1024 |
| B11 | 984 | 1106 | 1104 | 1176 | 1134 | 934 | 1024 |

As for the measured iron loss and magnetic flux density values, the values were measured by collecting the specimen at the edge corresponding to about 5% of the entire width of the steel sheet, the values were measured by collecting the specimen at the center portion corresponding to about 30% of the entire width of the steel sheet, an average value of each of the iron loss and magnetic flux density was measured and used as the value at the center portion, and then the values were compared.

In addition, the average values of the values of the iron loss and magnetic flux density of each specimen in the rolling direction and the direction perpendicular to the rolling direction were compared. The results are shown in Table 6.

TABLE 6

| | Magnetism at | | | | | | | | | | | | | |
|---|---|---|---|---|---|---|---|---|---|---|---|---|---|---|
| | center in front | | Magnetism at | | Front end | | Magnetism at | | Magnetism at | | | | | |
| | end width | | edge in front | | magnetism | | center in middle | | edge in middle | | Middle | | | |
| | direction | | end width | | ratio | | width direction | | width direction | | magnetism ratio | | | |
| | (1) | | direction (2) | | [%] (3) | | (4) | | (5) | | [%] (6) | | | |
| | | Magnetic | | Magnetic | | Magnetic | | Magnetic | | Magnetic | | Magnetic | | |
| Steel | Iron | flux | Iron | flux | Iron | flux | Iron | flux | Iron | flux | Iron | flux | Surface | |
| type | loss | density | loss | density | loss | density | loss | density | loss | density | loss | density | stripe | Reference |
| B1 | 3.33 | 1.71 | 3.55 | 1.67 | 6.61 | 2.34 | 3.25 | 1.71 | 3.45 | 1.67 | 6.15 | 2.34 | Good | Comparative |
| | | | | | | | | | | | | | | Example |
| B2 | 3.31 | 1.71 | 3.45 | 1.68 | 4.23 | 1.75 | 3.24 | 1.71 | 3.32 | 1.7 | 2.47 | 0.58 | Good | Comparative |
| | | | | | | | | | | | | | | Example |
| B3 | 3.3 | 1.73 | 3.55 | 1.7 | 7.58 | 1.73 | 3.25 | 1.73 | 3.35 | 1.71 | 3.08 | 1.16 | Good | Comparative |
| | | | | | | | | | | | | | | Example |
| B4 | 3.09 | 1.72 | 3.13 | 1.72 | 1.29 | 0.00 | 3.05 | 1.72 | 3.07 | 1.72 | 0.66 | 0.00 | Good | Inventive |
| | | | | | | | | | | | | | | Example |
| B5 | 3.12 | 1.74 | 3.17 | 1.73 | 1.60 | 0.57 | 3.07 | 1.74 | 3.1 | 1.73 | 0.98 | 0.57 | Good | Inventive |
| | | | | | | | | | | | | | | Example |
| B6 | 3.17 | 1.73 | 3.19 | 1.72 | 0.63 | 0.58 | 3.07 | 1.74 | 3.1 | 1.73 | 0.98 | 0.57 | Occurrence | Comparative |
| | | | | | | | | | | | | | of defects | Example |
| B7 | 3.45 | 1.68 | 3.66 | 1.66 | 6.09 | 1.19 | 3.41 | 1.68 | 3.44 | 1.67 | 0.88 | 0.60 | Good | Comparative |
| | | | | | | | | | | | | | | Example |
| B8 | 3.07 | 1.73 | 3.1 | 1.725 | 0.98 | 0.29 | 3.05 | 1.73 | 3.08 | 1.72 | 0.98 | 0.58 | Good | Inventive |
| | | | | | | | | | | | | | | Example |
| B9 | 3.32 | 1.69 | 3.55 | 1.66 | 6.93 | 1.78 | 3.3 | 1.69 | 3.47 | 1.66 | 5.15 | 1.78 | Occurrence | Comparative |
| | | | | | | | | | | | | | of surface | Example |
| | | | | | | | | | | | | | defects | |
| B10 | 3.45 | 1.72 | 3.64 | 1.69 | 5.51 | 1.74 | 3.38 | 1.72 | 3.57 | 1.7 | 5.62 | 1.16 | Poor | Comparative |
| | | | | | | | | | | | | | surface | Example |
| B11 | 3.04 | 1.74 | 3.06 | 1.736 | 0.66 | 0.23 | 3.01 | 1.74 | 3.02 | 1.735 | 0.33 | 0.29 | Good | Inventive |
| | | | | | | | | | | | | | | Example |

In Table 6, (1) “magnetism at center in width direction” represents the magnetism at the center in the width direction in the front end in the coil length direction, (2) “magnetism at edge in width direction” represents the magnetism at the edge in the width direction in the front end in the coil length direction, and (3) “magnetism ratio” represents the magnetism ratio between the edge and the center in the width direction in the front end in the coil length direction.

In addition, in Table 6, (4) “magnetism at center in width direction” represents the magnetism at the center in the width direction in the center in the coil length direction, (5) “magnetism at edge in width direction” represents the magnetism at the edge in the width direction in the center in the coil length direction, and (6) “magnetism ratio” represents the magnetism ratio between the edge and the center in the width direction in the center in the coil length direction.

As shown in Tables 4 to 6, in the cases of Inventive Examples in which, in the reheating of the slab, the residence time in the heating furnace was 180 minutes or longer, the finishing rolling conditions and the coiling temperature were controlled in the hot rolling performed uniformly stepwise in two or more stages, the iron loss value and the magnetic flux density value were excellent without the magnetic deviation in the length direction and the width direction of the coil, and the surface properties were also good.

The present invention is not limited to the exemplary embodiments, but may be prepared in various different forms, and it will be apparent to those skilled in the art to which the present invention pertains that the exemplary embodiments may be implemented in other specific forms without departing from the spirit or essential feature of the present invention. Therefore, it is to be understood that the exemplary embodiments described hereinabove are illustrative rather than restrictive in all aspects.

1. A non-oriented electrical steel sheet comprising, by wt %:
0.005% or less (excluding 0%) of C, 1.5 to 3.0% of Si, 0.4 to 1.5% of Mn, 0.005% or less (excluding 0%) of S, 0.0001 to 0.7% of Al, 0.005% or less (excluding 0%) of N, 0.005% or less (excluding 0%) of Ti, 0.001 to 0.02% of Cu, 0.01 to 0.05% of Sb, 0.001 to 0.1% of Sn, and 0.005 to 0.07% of P,
wherein contents of Mn, Si, and Al satisfy the following [Expression 1], contents of Sb, Sn, and P satisfy the following [Expression 2], the non-oriented electrical steel sheet contains a balance of Fe and unavoidably incorporated impurities, and the number of (Mn, Cu)S precipitates of 0.5 μm or less per area is 1/μm³ or less,
$$0.19 \leq [ Mn ] / ( [ Si ] + 150 \times [ Al ] ) \leq 0.35 \qquad [ Expression 1 ]$$
$$1 / {2}^{*} Sn < [ Sb ] + [ P ] < 0 \text{.09} \qquad [ Expression 2 ]$$
(wherein [Mn], [Si], [Al], [Sn], [Sb], and [P] are wt % of Mn, Si, Al, Sn, Sb, and P, respectively).

2. The non-oriented electrical steel sheet of claim 1, wherein:
in the electrical steel sheet, a number ratio (Fcount) of (Mn, Cu)S precipitates having a size of 0.05 μm or more to the (Mn, Cu)S precipitates of 0.5 μm or less is 0.2 to 0.5, and an area ratio (Fcount×Farea) of the (Mn, Cu)S precipitates having a size of 0.05 μm or more to the (Mn, Cu)S precipitates of 0.5 μm or less is greater than 0.15.

3. The non-oriented electrical steel sheet of claim 1, wherein:
the electrical steel sheet has a maximum height from the center line of 2.5 μm or less when measured in a length unit of 4 mm in a rolling direction based on the center line of a surface height, the electrical steel sheet has the number of concavo-convex defects having a height greater than a peripheral height and having a width of 0.5 μm or more in a direction perpendicular to the rolling direction and a size of 3 cm or more in the rolling direction of 1/cm or less per 10 cm in the direction perpendicular to the rolling direction, and a change in {100} and {110} fractions at different positions of the electrical steel sheet is less than 10%.

4. The non-oriented electrical steel sheet of claim 1, wherein:
in the steel sheet, a difference in iron loss values between an edge portion and a center portion in a coil width direction is 5% or less, and a difference in magnetic flux density values between the edge portion and the center portion in the coil width direction is 5% or less.

5. The non-oriented electrical steel sheet of claim 1, wherein:
a thickness of an inner oxide layer of the electrical steel sheet based on a hot-rolled sheet of the electrical steel sheet is 7 μm or less.

6. A method for manufacturing a non-oriented electrical steel sheet, the method comprising:
preparing a slab containing, by wt %, 0.005% or less (excluding 0%) of C, 1.5 to 3.0% of Si, 0.4 to 1.5% of Mn, 0.005% or less (excluding 0%) of S, 0.0001 to 0.7% of Al, 0.005% or less (excluding 0%) of N, 0.005% or less (excluding 0%) of Ti, 0.001 to 0.02% of Cu, 0.01 to 0.05% of Sb, 0.001 to 0.1% of Sn, and 0.005 to 0.07% of P, in which contents of Mn, Si, and Al satisfy the following [Expression 1] and contents of Sb, Sn, and P satisfy the following [Expression 2], the slab containing a balance of Fe and unavoidably incorporated impurities;
reheating the slab at a temperature that satisfies the following [Expression 5];
hot rolling the reheated slab to manufacture a hot-rolled sheet;
coiling the hot-rolled sheet into a coil shape;
pickling the coiled hot-rolled sheet and cold rolling the pickled hot-rolled sheet to manufacture a cold-rolled sheet; and
subjecting the cold-rolled sheet to final annealing,
$$0.19 \leq [ Mn ] / ( [ Si ] + 150 \times [ Al ] ) \leq 0.35 \qquad [ Expression 1 ]$$
$$1 / {2}^{*} Sn < [ Sb ] + [ P ] < 0 \text{.09} \qquad [ Expression 2 ]$$
$${MnS}_{SRT} / {MnS}_{Max} \geq 0.6 \qquad [ Expression 5 ]$$
(wherein [Mn], [Si], [Al], [Sn], [Sb], and [P] are wt % of Mn, Si, Al, Sn, Sb, and P, respectively, MnS_{SRT} is an equilibrium precipitation amount of MnS, and MnS_{Max} is a maximum precipitation amount of MnS).

7. The method of claim 6, wherein:
the reheating of the slab is performed to a temperature that satisfies [Expression 6],
$$S R T \geq A 1 + 150 ° C . \qquad [ Expression 6 ]$$
(wherein SRT is a slab reheating temperature, and Al is a temperature at which 100% of austenite is transformed into ferrite).

8. The method of claim 6, wherein:
in the reheating of the slab, the slab is heated stepwise in two or more stages by setting a residence time to 100 minutes or longer.

9. The method of claim 6, wherein:
in the reheating of the slab, the slab is heated stepwise in three or more stages by setting a residence time to 100 minutes or longer,
a first stage heating is performed at a temperature of (SRT_max−50°) C or lower for 50 minutes or longer, a second stage heating is performed at a heating temperature (SRT2) in a heating furnace at a stage before the last stage that satisfies A3 temperature+70° C. or lower and A1+120° C. or higher, and the last heating is performed at SRT_max≥A1+150° C., (wherein SRT_max represents the highest temperature among slab reheating temperatures (SRT) in [Expression 6]).

10. The method of claim 6, wherein:
when finishing rolling is performed in the hot rolling, a temperature just before the start of the finishing rolling is a temperature of A1−50° C. or higher and A1+40° C. or lower.

11. The method of claim 6, wherein:
when finishing rolling is performed in the hot rolling, among a plurality of rolls, a reduction ratio of a roll just before the last roll is 21% or more, and a reduction ratio of the last roll is 13% or more.

12. The method of claim 6, wherein:
the coiling is performed at 650 to 800° C.

13. The method of claim 6, wherein:
the coiling is performed by controlling the temperature according to contents of Sn and Sb at a temperature calculated according to the following [Expression 3] and/or [Expression 4]:
$${0.000165}^{*} C T - 0.085 < \{ 1 / {3}^{⋆} [ Sn ] + [ Sb ] \} < 0 \text{.13} \qquad [ Expression 3 ]$$
$${0.000165}^{*} C T - 0.0934 < [ Sb ] < 0.05 \qquad [ Expression 4 ]$$
(wherein [Sn] and [Sb] are wt % of Sn and Sb, respectively, and CT is an average coiling temperature at a length of 30% of the total length located in the center in a length direction during the hot rolling).

14. The method of claim 6, wherein:
the coiling is performed according to the following [Expression 7] in which a temperature at a front end of the coil is higher than a temperature at a middle portion of the coil by 20° C. or more:
$$( Maximum coiling temperature at \\ le ngth from start point to point of 5 \% of total length \\ in coil length direction ) \geq ( average coiling temperature at length of 30 \% to \\ 50 \% of total length in coil length direction ) + 20 ° C . \qquad [ Expression 7 ]$$

15. The method of claim 6, wherein:
in the coiling of the hot-rolled sheet, the coiled coil is cooled while being put into a cooling facility and covered with a heat retention cover.

16. The method of claim 6, wherein:
the final annealing is performed in a temperature range of 850 to 1,100° C.
